(19) United States
(12) Patent Application Publication
(10) Pub. No.: US 2003/0079188 A1
(43) Pub. Date: Apr. 24, 2003

(54) Method of multi-topology optimization

(75) Inventors: Trent Lorne McConaghy, Ottawa (CA); Evgeny Vladimirovich Ivanov, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Analog Design Automation Inc.

(21) Appl. No.: 10/271,537

(22) Filed: Oct. 17, 2002

Related U.S. Application Data
(60) Provisional application No. 60/329,546, filed on Oct. 17, 2001.

(51) Int. Cl. G06F 17/50

(52) U.S. Cl. 716/2; 716/18; 716/10; 716/12

(57) ABSTRACT

A method of multi-topology optimization is used in AMS circuit design to address the problem of selecting a topology while sizing the topology. First, design schematics are manually or automatically selected from a database of known topologies. Additional topologies can be designed as well. For each candidate design there is associated a topology and a set of parameters for that topology. Analogously to the step of automatic sizing for a single topology, multi-topology optimization comprises optimizing over the entire population of design simultaneously while not requiring that all topologies are fully optimized. The multi-topology optimization step is repeated until one or more stopping criteria are satisfied. The sized schematic is then passed onto placement, routing, extraction and verification.

The present application claims priority from U.S. Provisional Patent Application No. 60/329,546 filed on Oct. 17, 2001.

### FIELD OF THE INVENTION

The present invention relates to design methodologies, and particularly to design methodologies employing an optimizer.

### BACKGROUND OF THE INVENTION

Design methodologies are used to solve many different types of design problems, including, for example, the design of analog and mixed signal (AMS) circuits. An approach to AMS circuit design uses a hierarchical methodology such as a top-down methodology (see e.g. H. Chang, E. Charbon, U. Choudhury, A. Demir, Felt, E. Liu, E. Malavasi, A. Sangiovanni-Vincentelli, E. Charbon, and I. Vassiliou, A Top-down, ConstraintDriven Design Methodology for Analog Integrated Circuits, Kluwer Academic Publishers, 1996). For example, referring to FIG. 1, a design problem could relate to designing a system that has among its components an active filter and a phase-locked loop. The design of the active filter could itself involve sub-components such as operational amplifiers denoted in FIG. 1 by opamp1 and opamp2.

Each of these entities, namely system 90, active filter 92, PLL 94, opamp1 96 and opamp2 98 of FIG. 1 is a node in the design hierarchy and is associated with a corresponding design problem. The present invention is applicable in helping to solve the design problem at each node. FIG. 2 is a general description of the problem of AMS design at each node, in terms of the inputs and outputs for the node. As illustrated, the design process to create the inputs from the outputs involves the sub-processes of synthesis, placement, routing, extraction and verification. Synthesis is the process of determining an appropriate topology and its corresponding circuit component values to achieve the design objectives and constraints. “Topology” refers to the structure of a circuit in terms of how components are connected to each other. Each of these sub-processes can be achieved by different combinations of manual and automatic processes, as will be described.

Referring to FIG. 3, one approach to AMS design is a manual approach to almost all of the steps in the process. The designer initially selects or designs a schematic s100. Then the designer tries different device sizes at step s200. Then using the SPICE simulator, the performance of the design is simulated at step s300. The sizes can then be varied if the performance is unsatisfactory with further simulation at step s300. This continues until the sizing is satisfactory. Then the steps of manual placement s400, manual routing s500, extracting s600, manual verification s700 and SPICE simulation s800 follow. The manual approach is still largely practiced in industry today.

FIG. 4 illustrates an approach in which at least the steps of topology selection s100 and parameter sizing s200 are manual. Topology selection is done by an designer such as an analog engineer looking at past topologies that would have solved similar circuit design problems. The designer considers the topologies which have the potential to meet the design objectives and specifications. These topologies may be with a company's own internally designed topologies, publicly known topologies such as those in textbooks, or topologies licensed from elsewhere.

Sometimes, the designer uses one or more previous topologies as starting points in the design of new topologies, for example, by adding a resistor across two nodes in a previous topology. Once the topology has been selected, the designer proceeds to sizing followed by placement, routing, extraction and verification s900. Some or all of these other steps may be manual or automatic.

A problem with this approach is that it is very slow. Manual topology selection takes some time and manual sizing takes a lot of time. In addition, this approach relies on expert knowledge of topologies so that the right choices are made.

Another approach, illustrated in FIG. 5, involves automatic sizing s210 on one topology per optimization and manual re-looping to topology selection. In this approach, the designer first manually selects the most promising topology s100. That topology gets run through an automatic sizing tool at step s210 then the designer examines the results. If the designer is satisfied with the results, then he or she continues the rest of the design process s900. If the designer is not satisfied, the designer re-loops to topology selection s100, to try to find the next most promising topology. If necessary, the designer will design a new topology.

A problem with this approach is that it relies on expert knowledge of topologies so that the right choices are made. This approach also has the potential to be very iterative. Furthermore, human involvement is required which slows things down. If the first topology is not good enough, a second will need to be optimized, and so on.

FIG. 6 illustrates an approach which fully optimizes all topologies. In this approach, the designer provides a set of topologies s100 to the automated sizing tool. The automated sizing tool, in a brute-force manner, fully optimizes all topologies s140. The automated sizing tool may or may not have a recommended topology. The user examines the results, and the recommendation, if there is one, then choose a topology and proceeds.

If each optimization takes a considerable amount of time, then this approach can take too long to be practical. Currently, most optimizations do take a considerable amount of time.

FIG. 7 illustrates an approach which optimizes some topologies. In this approach the tool can perform optimization as well as have awareness of the different available topologies. It will optimize one or many topologies at once and analyze the results of those optimization runs s150. Based on those results the tool will either proceed to try other topologies or stop. The topologies can be organized in some predetermined manner, such as a decision tree.

This approach relies on expert knowledge of topologies so that the right choices are made. If each optimization takes a considerable amount of time, then this can take too long to be practical. Currently, most optimizations do take a considerable amount of time. A shortcut is to use local optimizations which do not take as much time. The tradeoff, however, is that the solution is not globally optimal. In addition, in the worst case, it may amount to fully optimizing all topologies.

Another approach is the Mixed-Integer “Substructure Swapping” Approach (see, e.g. P. C. Maulik, R. L. Carley, R. A. Rutenbar, “Integer Programming Based Topology Selection of Cell-Level Analog Circuits.” IEEE Transactions on Computer-Aided Design of Circuits and Systems, Vol. 14 (4), April 1995). This approach views the problem of topology selection as having one base topology, with a set of swappable substructures. Each substructure is indexed by an integer. The problem is formulated as an integer-programming problem (if there are just integers or discrete variables to optimize) or a mixed-integer problem (if there are also continuous variables).

This approach comes up with novel topologies which may not be familiar and may not be trusted. In addition, the set up of the problem may be awkward or unnatural.

Still another approach is the structural synthesis approach. This approach ignores the problem of topology selection by trying to automatically create the structures themselves, along with the parameters. This approach comes up with novel topologies which may not be familiar and may not be trusted.

Accordingly, it is desirable to facilitate rapid analysis and comparison among topologies while working within an existing set of proven technologies that the designer can trust.

### SUMMARY OF THE INVENTION

It is an object of the present invention to obviate or mitigate at least one disadvantage of previous methods associated with known methods of topology optimization. It is a further object of the present invention to speed the process of selection of unsized schematics for use in sizing circuits.

According to an aspect of the present invention there is provided a method of determining at least one optimized design based on a plurality of sets of design candidates, each set of design candidates corresponding to a respective candidate design approach, each design candidate having a corresponding objective function value, the method comprising: taking the union of the plurality of sets of design candidates (i.e. forming the union of the plurality of sets of design candidates by creating a new union set which includes all elements of each set of design candidates); determining a population based optimization algorithm for application to the union of the plurality of sets of design candidates; determining, based on the objective function values of the design candidates, a subset of the union; and applying the population based optimization algorithm to the design candidates in the subset to determine the at least one optimized design.

According to another aspect of the present invention there is provided a method of circuit design comprising receiving a circuit design problem definition and biases and producing a circuit design, the method comprising: determining schematics; simultaneously optimizing all schematics; and selecting a sized schematic for subsequent processing.

An advantage of the present invention is the ability to design circuits more quickly. A further advantage is being able to better understand the tradeoffs among alternative designs.

Although the present invention is presented in the context of circuit design example, method of the present invention is applicable to many other types of design problems including, for example, design problems relating to scheduling, chemical processing, control systems, neural networks, regression modelling unknown systems, molecular synthesis, optical circuits, photonics, communications networks, sensors and flow network design problems such as road systems, waterways and other large scale physical networks, optics, mechanical components and opto-electrical components.

In typical embodiments, the present invention leverages the unification of parameter-based design spaces across multiple structures a via population-based optimization algorithm. In circuit design, disparate parameter-based design spaces of the different topology structures are unified. For neural networks, disparate parameter-based design spaces (“weights”) across multiple different neural network topologies are unified.

The present invention can be extended via providing a means of visualization of objective function values in a manner that abstracts away the details of the underlying design space. Then, the user selects the design based on performances, and the actual implementation of the design (e.g. specific topology and parameters) becomes secondary.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Embodiments of the present invention will now be described, by way of example only, with reference to the attached drawings, wherein:

FIG. 1 illustrates an example design hierarchy for a system;

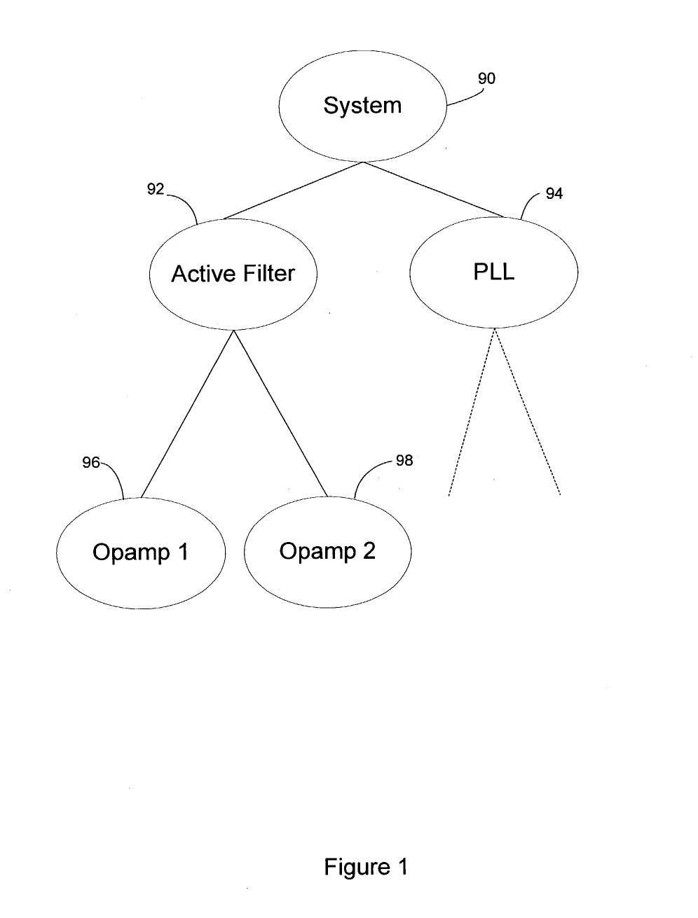

FIG. 2 illustrates a known basic set up of AMS circuit design at one node in the design hierarchy of FIG. 1;

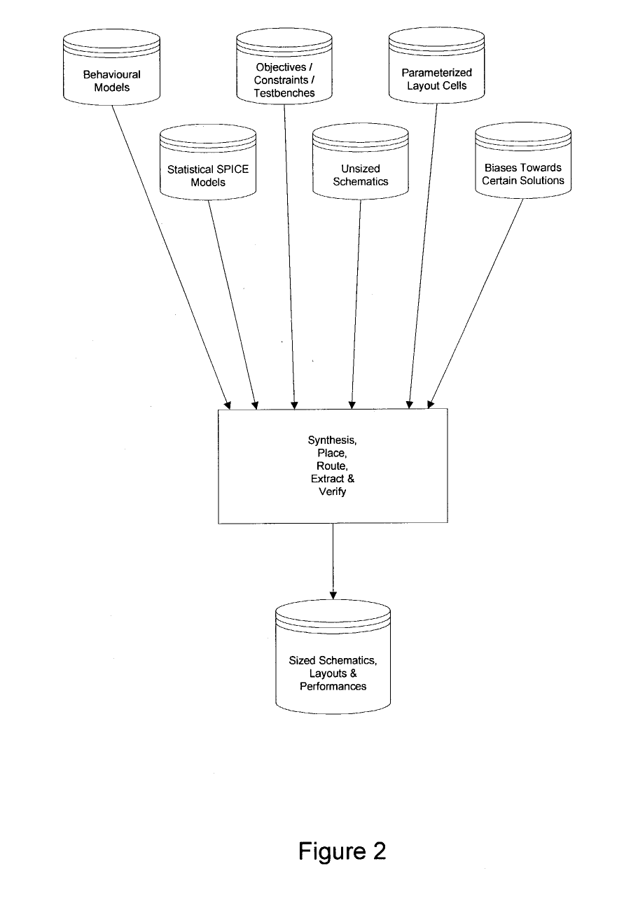

FIG. 3 illustrates a fully manual approach to AMS circuit design;

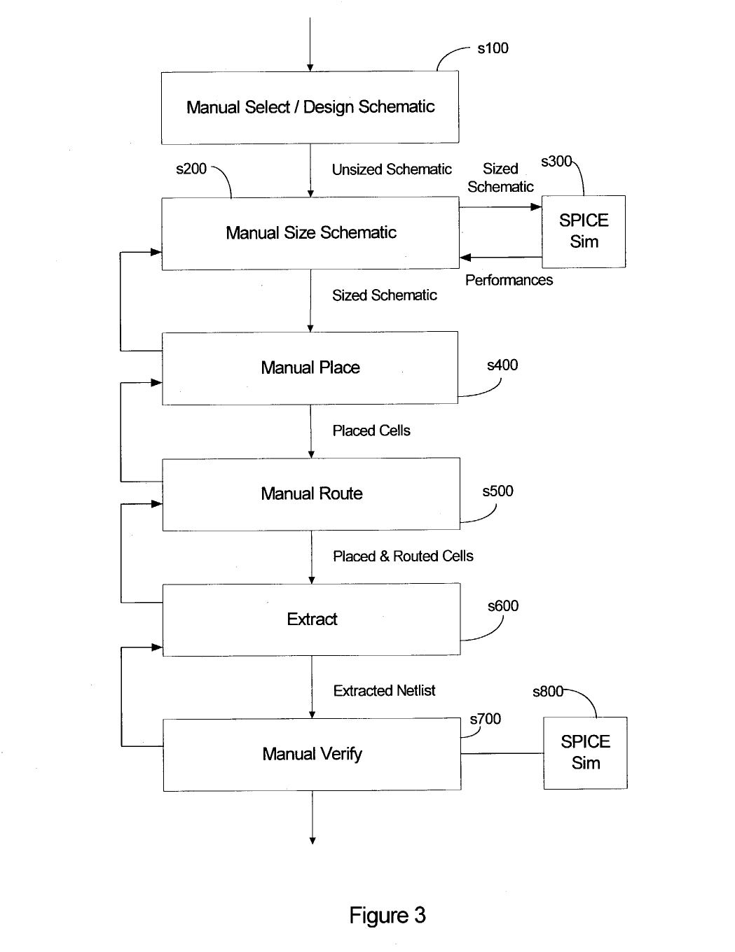

FIG. 4 illustrates an approach in which at least topology selection and parameter sizing are manual;

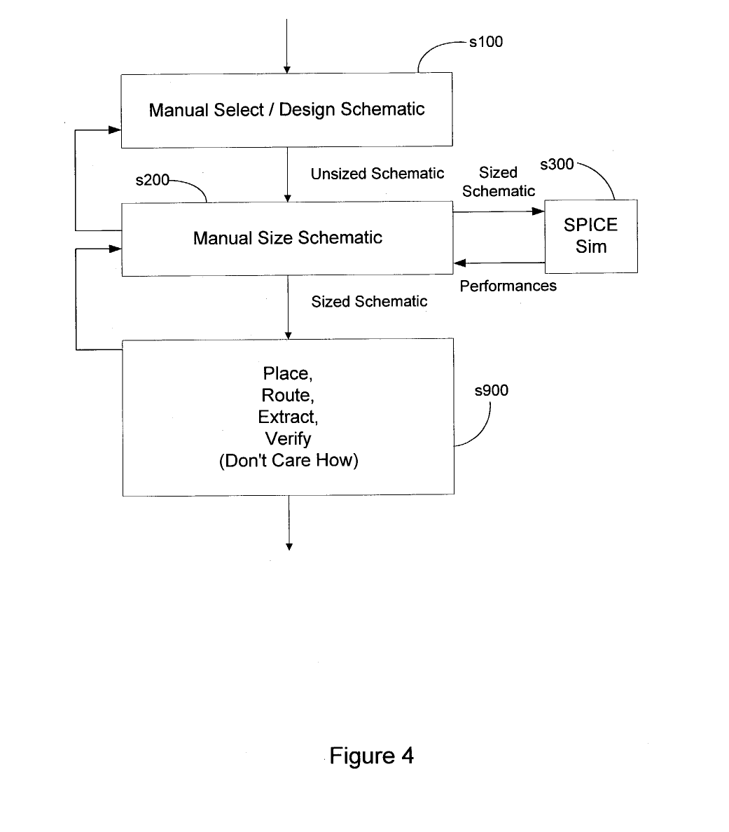

FIG. 5 illustrates an approach in which automatic sizing is performed on one topology per optimization with topology selection still a fully manual process;

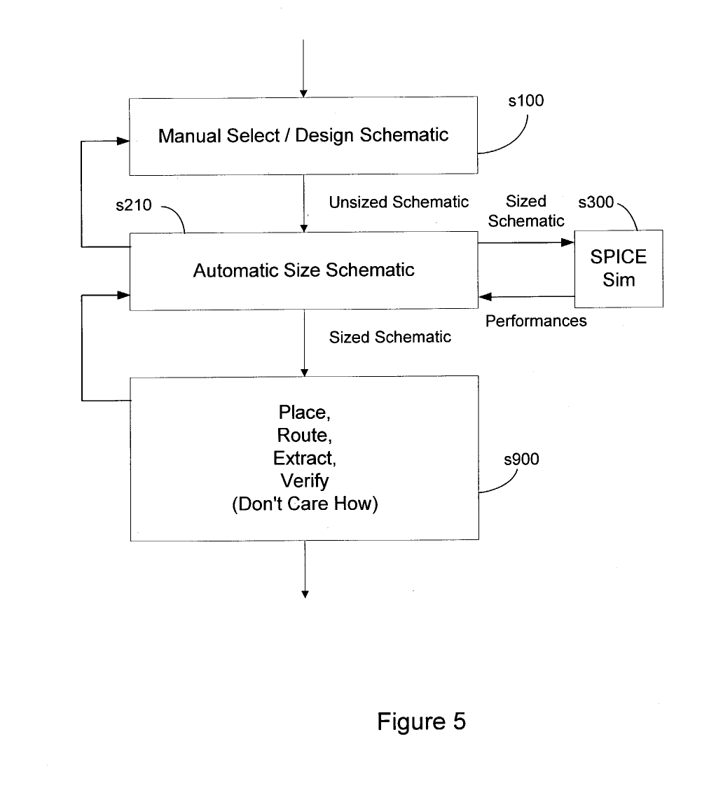

FIG. 6 illustrates an approach in which a set of topologies are fully optimized at once;

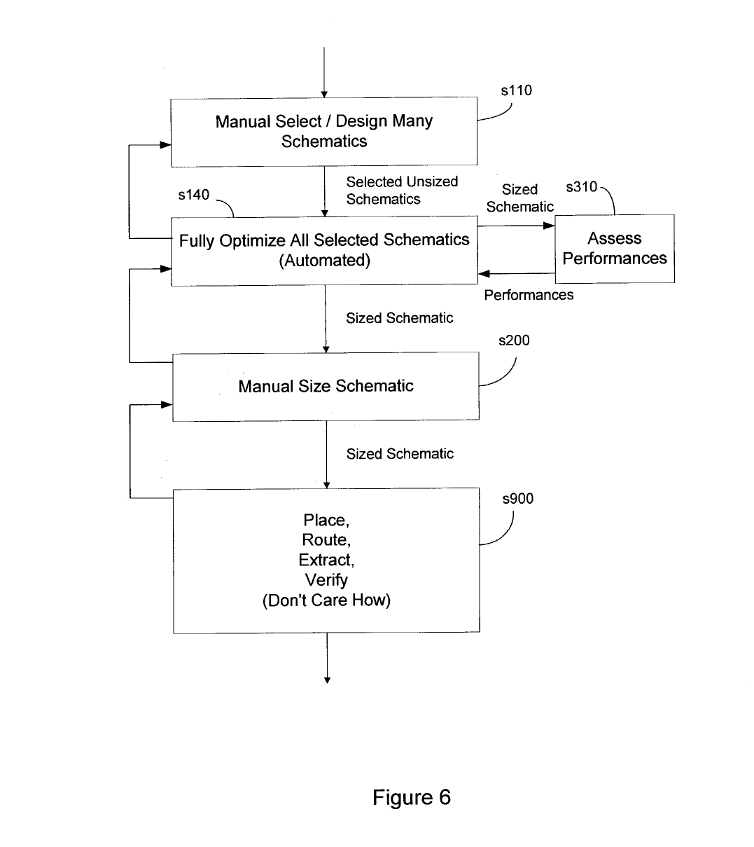

FIG. 7 illustrates an approach in which some topologies are fully optimized and topologies are automatically selected;

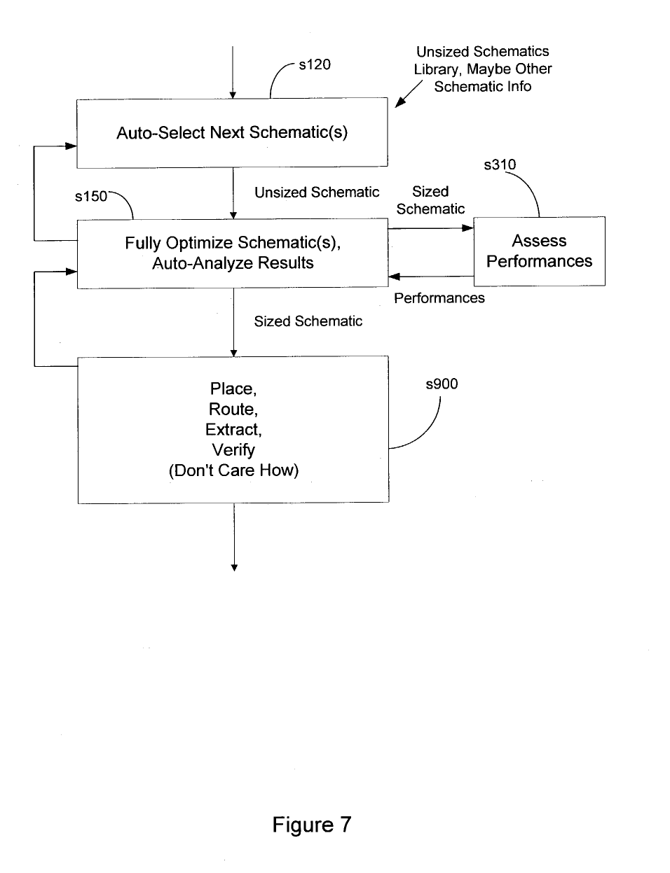

FIG. 8 illustrates an embodiment of the present invention;

FIGS. 9A to 9C illustrate conceptually the principle of the present invention;

FIG. 10 illustrates an example of the present invention using an evolutionary algorithm; and

FIG. 11 illustrates an example of the present invention using an A-Teams algorithm.

### DETAILED DESCRIPTION

Generally, the present invention provides a method for solving part of the synthesis, place, route, extract and verify (SPR) problem, namely the problem of selecting a topology, in conjunction with the problem of sizing the topology.

The following terms are used in the examples and discussion below.

A set H is a subset of set G if each element of H is also an element of G. Note that by this definition, G is a subset of itself. Accordingly, if H is said to be a subset of G then the possibility that H is equal to G is not excluded.

The expression “optimize” is used in a procedural sense of, for example, a search engine employing an optimizer or optimization algorithm, and not necessarily in an absolute or global sense. Accordingly, when a design has been optimized, we mean that a search has been conducted and the best results, according to specified criteria, have been identified. This does not, however, guarantee that other better results do not exist or that they cannot be found with additional searching.

The expression “population based optimization algorithm”, refers to an algorithm which begins with an initial population of individuals or design candidates and iteratively operates on the population to select high quality individuals from the population and uses the selected individuals to generate successive populations or generations of individuals. During this process, the best individuals (or design candidates) according to evaluation criteria, typically formulated in a scalar or vector valued objective function, are identified. When one or more stopping criteria are satisfied, the best individuals or design candidates identified thus far are the returned as the result of the algorithm.

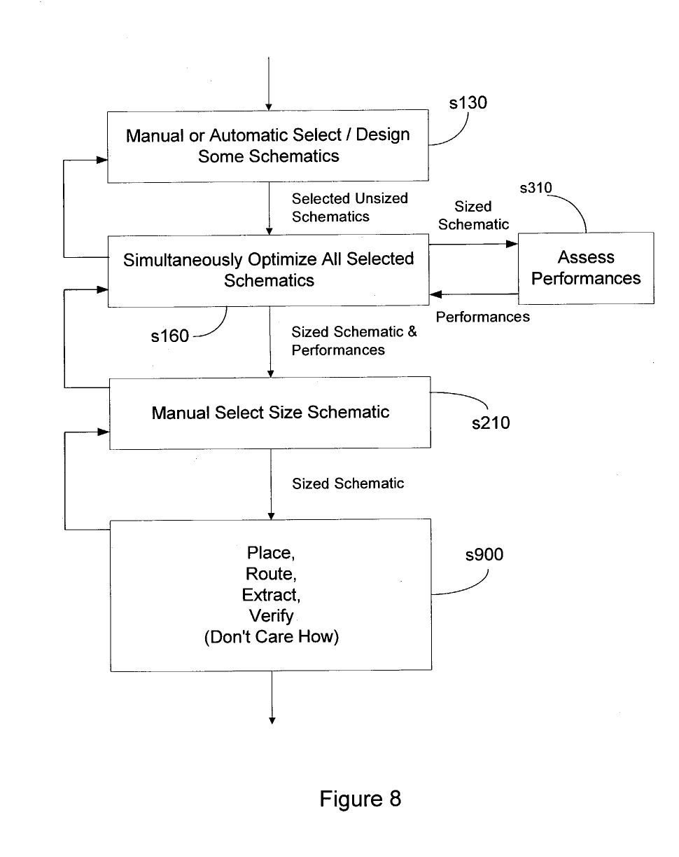

FIG. 8 illustrates the general steps of the present invention. Referring to FIG. 8, according to an embodiment of the present invention, a method of multi-topology optimization begins with the selection and design of schematics s130. Typically, on the order of 2-200 topologies are selected manually or automatically from the set of topologies that the designer has access to. In many cases, the whole set of topologies may be selected, thereby eliminating the need for any selection criteria.

The second step s160 is the extension of automatic sizing for a single topology to handle multiple topologies. The design space of automatic sizing for a single topology is the set of parameters for that single topology. The design space for the optimization of the present invention is the set of topologies T and for each topology t in T, the parameters for t. Therefore, every candidate design point includes (a) a topology and (b) a set of parameters for that topology. Some of the key features of this step are:

the topologies are optimized simultaneously; and

not all topologies are fully optimized; there is a dynamic adaptation to spend more time on the promising topologies and less time on the less promising topologies.

Example algorithms that support the key features of this step will be described below. A population based algorithm with the right heuristics can meet the key features.

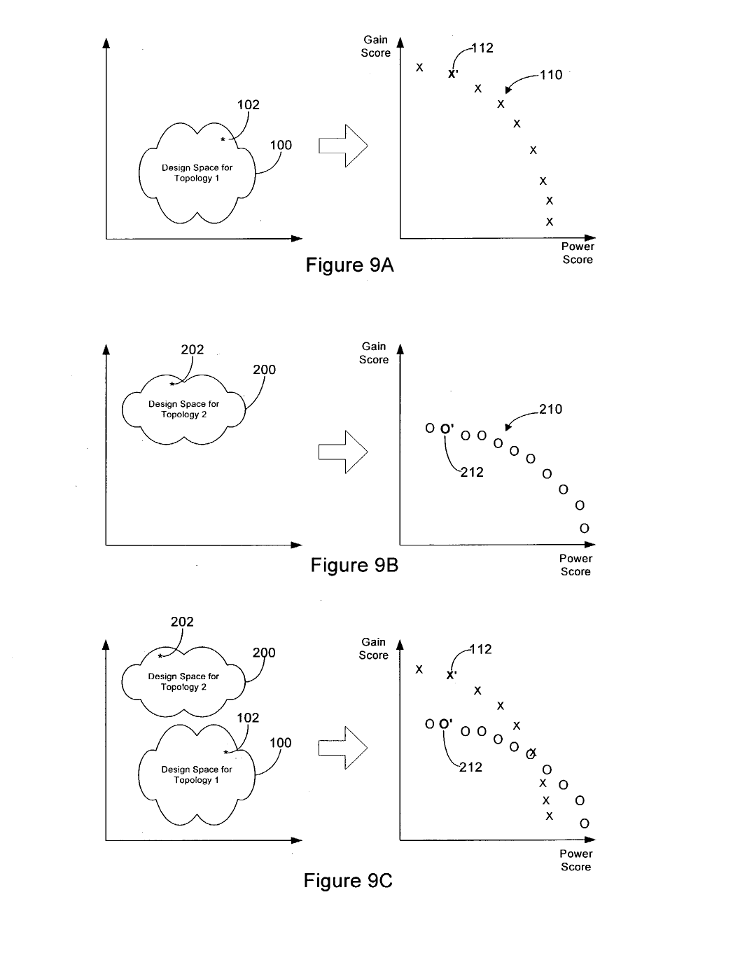

Referring to FIGS. 9A to 9C, this example tries to maximize all the objective functions. The idea behind the second step s160 of the present invention can be conceptually summarized as follows. An objective function (or multiple objective functions) maps a design space to an objective function space (or performance space) for each topology or design candidate. Of course, the domain of each objective function will depend on the topology and its parameters. The assessment of performance can be done by leveraging testbenches and simulation or by functions or by other means and need not be limited to just relying on testbenches and simulation.

FIGS. 9A and 9B illustrate the mapping of two design spaces 100, 200 for topologies corresponding to two different designs into respective objective function spaces. In FIG. 9A, the candidates indicated by “X”s in the objective space and collectively designated by 110 represent optimized designs corresponding to design space 100 found by a suitable process. Note that no optimized design is dominated by another optimized design and the locus of “X”s represents a tradeoff curve for design space 100. (A design A dominates design B if design A has better performance than design B for every objective. A nondominated design is one which is not dominated by any other designs). It is the set of current nondominated designs which form the current tradeoff curve.

Similarly, in FIG. 9B the “O”s in the objective function space collectively designated by 210 represent optimized designs corresponding to design space 200. Again no optimized design dominates another one along the locus of “O”s and they collectively represent a tradeoff curve for design space 200.

However, it can be seen that some of the optimized designs corresponding to topology 2 are dominated by optimized designs corresponding to topology 1. In other words, certain designs candidates such as 202 corresponding to topology 2 (and associated parameters) would never be chosen because better results could be obtained by using a circuit (design candidate 102) having topology 1 (and associated parameters).

This is clearly illustrated in FIG. 9C in which the two topologies are simultaneously optimized and the results are shown in a common objective function space. The key point here is that the optimizer has to do less work. Assuming that previously a single optimizer could be applied to design spaces 100, 200, that same optimizer can be used on the union of the two separate domains. We see from FIG. 9C that the design candidate 202 corresponding to objective function 212 is dominated by the design candidate 102 corresponding to objective function value 112. The optimizer is able to do less work since candidates such as 202 can be eliminated, assuming a suitable optimization process. For example, if candidate 102 were evaluated prior to candidate 202, the optimizer could, according to known heuristics, choose to avoid evaluating candidate 202 thereby increasing the speed and efficiency of the optimization step.

The third step s210 of the present embodiment is to select a sized schematic to pass onto placement, routing, extraction and verification s900. The designer can use the output of the second step s160 to aid this process, namely, the set of sized schematics and the corresponding performances. The output of the second step s160 can be organized for easy analysis. For example, it could be provided as a set of points in the tradeoff curve of objective function space. Each point in the tradeoff curve would correspond to a specific topology and specific sizings for that topology. Some topologies might not even be on the tradeoff curve. This tradeoff curve might be displayed via, for example, a textual browser or via a graphical plot. In this manner, the designer can quickly understand the tradeoffs among the topologies.

Based on the analysis of the designs and their performances, the designer can choose a particular sized schematic. Note that the designer can also analyze topologies and performances during the course of the optimization, in order to understand the progress of the search, to understand how well the topologies stack up against each other earlier on and to bias the search towards different regions of performance and design space. It is also possible for the designer to use the analysis to stop the search.

As mentioned earlier, a population-based algorithm with the right heuristics can meet the key features. Evolutionary algorithms are a very well-known class of population-based algorithms. Next, an example evolutionary algorithm is presented followed by an alternative variation which uses an A-Team algorithm in the second step.

The following notation is used:

T—set of topologies that have been made available to the optimization algorithm.

P—“population” of “individuals”, that is, a set of design points. Each individual is a topology, plus the parameters that describe that topology.

W—“winning” individuals: individuals that emerged as winners from the evaluation and selection mechanisms; these may even be variations of P, for example if individuals in P were locally optimized.

R—this is the set of preferred results that is accumulated over time. This set can be used for diversity preserving measures, for determining tradeoffs in objective function space for multiobjective optimization, and aiding other convergence-based heuristics. It is desirable to always maintain at least one individual for each topology within R.

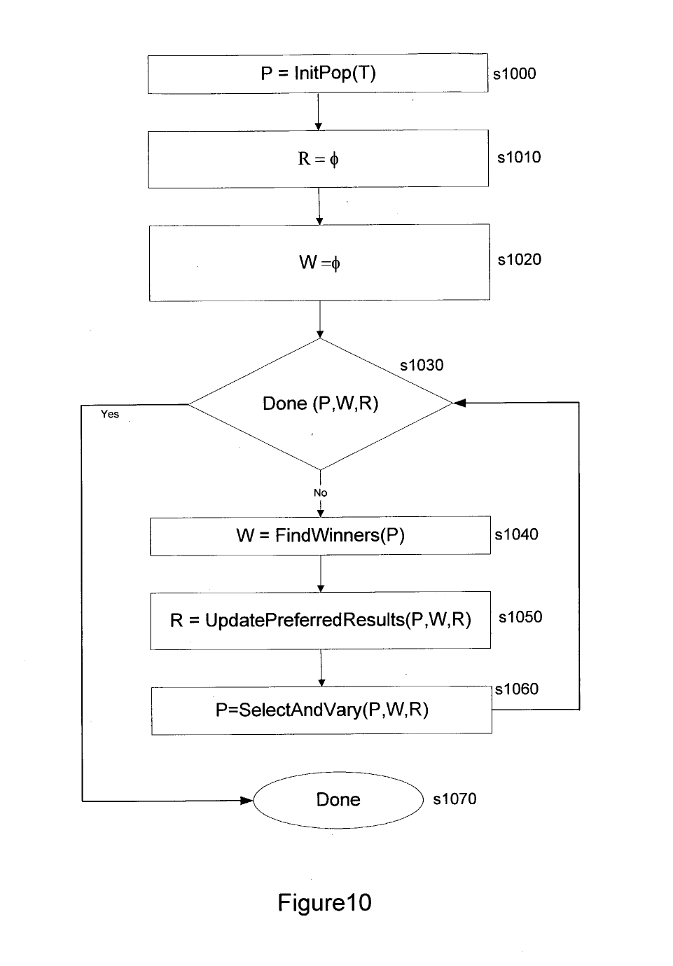

FIG. 10 is an example of embodiment of the invention within a specific algorithm. What sets this invention apart is that the population of candidates do not all share the same topology as in some approaches, and it does not invent new topologies on the fly, as in other approaches. Rather, it uses the union of the design spaces of the topologies that it is given. Thus, when the population is initialized or operators occur, no new topology is ever invented, yet more than just a single topology is being used. Referring to FIG. 10, a base evolutionary algorithm is now presented:

P=InitPop(T)

R=ø

W=ø

While not Done(P, W, R)

W=FindWinners(P)

R=UpdatePreferredResults(P, W, R)

P=SelectAndVary(P, W, R)

The methods used are now described:

InitPop (T:set<topology>):pop creates an initial population P from the set of topologies that have been made available to the optimization algorithm. Each of the topologies t may have 0, 1, or more suggested parameter configurations. In addition to suggested parameter configurations, parameters may be set by randomly drawing from probability distributions. If there are n topologies in T, then P must contain at least n individuals—one individual per topology. If there are >n individuals in T, then the other topologies could be chosen completely randomly with uniform bias. Returns P.

Done(P:pop, W:pop,R:pop):bool returns true if stopping criteria have been satisfied. Criteria may include, but are not constrained to:

return true if the user has asked the algorithm to stop;

return true if performance convergence has stagnated;

return true if the design points in the population have all converged to the same design; or

return true if all the constraints have been met.

FindWinners(P:pop):pop is a combination of evaluation and selection. There are a variety of ways to implement this method. Some examples include:

Single-Objective. P=Evaluate(P) by first simulating the circuits on performance measuring testbenches, then assigning a scalar objective function value to each individual in P according to a predetermined objective function. Then W=Select(P) to select winners from P according to a selection strategy such as roulette wheel selection, rank-based selection, or tournament selection. Roulette wheel selection selects individuals with a probability proportional to the objective function value. Rank-based selection first ranks the individuals according to objective function value, then assigns new scalar objective function values according to rank, then performs a roulette-wheel selection on the new objective function values. Tournament selection lines up a set of tournaments; each tournament contains two or more individuals selected uniformly from the population; W holds the winner from each tournament. Return W.

Multi-Objective. P=Evaluate(P) by first simulating the circuits on performance measuring testbenches, then assigning a vector-value objective function value to each individual in P according to set of predetermined objective functions. Then W=Select(P) to select winners from P according to a selection strategy tuned for vector-value objective functions. Return W.

Local-Optimizer (Memetic). P′=Locallyoptimize(P) in which each individual is optimized with an algorithm that has good hill-climbing characteristics, such as gradient-based search, generalized pattern search, or variants of simulated annealing. Then W=Select(P′) to select winners from P′ according to a selection strategy such as roulette wheel selection or tournament selection. Return W.

UpdatePreferredResults(P:pop,W:pop,R:pop):pop returns an update of the set of preferred results. Some examples include:

Single-objective simple elitism. Set R to hold the individual with the best scalar objective function value. Return R.

Diversity-preserving update in single-objective optimization. Set R to hold one or more individuals for each topology, and those individual(s) are the individual(s) with the best objective function value(s) for that topology, chosen from the union of P, W, and R. Return R.

Multi-objective optimization I. Let N=all nondominated individuals from the union of P, W, and R. A nondominated individual is an individual in which no other individual is better on all objective function measures. Given N, choose individuals for R to hold up to maxSizeR individuals to best approximate the tradeoff curve in a vector-valued objective function space. Return R.

Multi-objective optimization II. Let N=all nondominated individuals from the union of P, W, and R. Given N, choose individuals for R to hold up to maxSizeR individuals with the best scalar objective function value, according to some scalar objective function, such as weighted sum. Return R.

SelectAndVary(P:pop,W:pop,R:pop):pop uses the information in P, W, and R to create a new population including at least some new design points, to try to shift the population towards more promising regions of the design space. Examples include:

Evolutionary-programming(EP)-like. Let U=union of W and R. Then, also using the self-adapting step sizes in each individual in U, apply gaussian mutation to the individual to get P. Return P.

Genetic-algorithms(GA)-like. Let U=union of W and R. There is a probability pr of applying the reproduction operator, p_{c} of applying crossover, and pₘ of applying mutation, with the relation pᵣ+p_{c}+pₘ=1. For each individual i_{U} in U an operator for the creation of a new individual, iₚ, in P is probabilistically chosen. Reproduction merely copies i_{U} into iₚ. Crossover (which would need two individuals of the same topology, even changing i_{U} if needed) would take the vector of design parameters in i_{U} and another randomly individual with the same topology as i_{U} (change i_{U} if i_{U} is the only individual with that topology), and essentially “interpolate.” For example, each entry in the new vector could be constructed by randomly choosing from between the corresponding entries in i_{U} and the other individual. Mutation could be accomplished by randomly perturbing one or more of the design parameters. Return P.

Injection of Preferred with GA or EP. Let U=(uniformly select a set of individuals from W) plus (select a set of individuals from R according to a selection criteria). Then apply the EP or GA operators as just described. Return P.

An alternative algorithm is the Asynchronous Teams of Autonomous Agents (A-Teams) algorithm (see, for example, “Cooperation Schemes for Autonomous Agents”, 1966 by S. N. Talukar, et al.). “An asynchronous team (A-Team) is a strongly cyclic computational network. Results are circulated through this network by software agents. The number of agents can be arbitrarily large and the agents may be distributed over an arbitrarily wide area. Agents cooperate by working on one another's results. Each agent is completely autonomous (it decides which results it is going to work on and when). Results that are not being worked on accumulate in shared memories to form populations. Randomization (the effects of chance) and destruction (the elimination of week results) play key roles in determining what happens to the populations.” (see A-Teams Project Home Page http://www.cs.cmu.edu/afs/cs/project/edrc-22/project/ateams/WWW/, S. N. Talukdar).

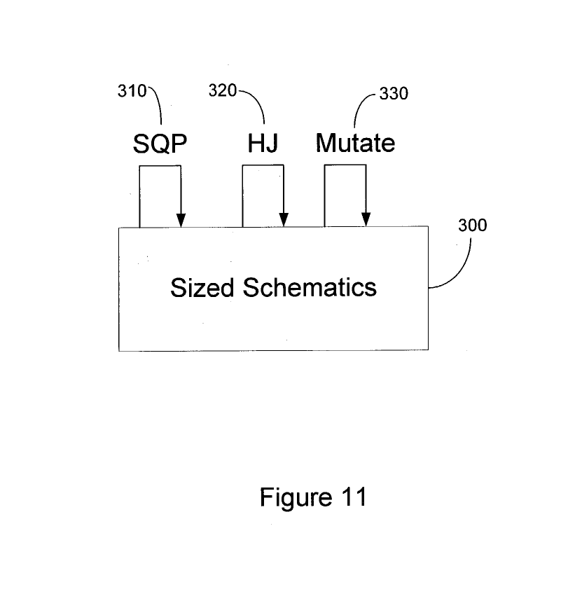

One can think of A-Teams as a macro-algorithm. It can incorporate the best of other algorithms. While it is population-based, it cannot accurately be labelled an evolutionary algorithm. FIG. 11 is an example of a simple A-Teams algorithm in which agents 310, 320 and 330 act asynchronously to optimize the sized schematics 300. In that example, agent 310 is the SQP approach (Sequential Quadratic Programming), agent 320 is Hooke-Jeeves and agent 330 is mutation. Of course, other suitable approaches are also possible.

The above-described embodiment(s) of the present invention are intended to be examples only. Alterations, modifications and variations may be effected to the particular embodiments by those of skill in the art without departing from the scope of the invention, which is defined solely by the claims appended hereto.

What is claimed is:

1. A method of determining at least one optimized design based on a plurality of sets of design candidates, each set of design candidates corresponding to a respective candidate design approach, each design candidate having a corresponding objective function value, the method comprising:
taking the union of the plurality of sets of design candidates;
determining a population based optimization algorithm for application to the union of the plurality of sets of design candidates;
determining, based on the objective function values of the design candidates, a subset of the union; and
applying the population based optimization algorithm to the design candidates in the subset to determine the at least one optimized design.

2. The method of claim 1, wherein determining a subset of the union comprises:
determining, based on the objective function values of the design candidates, a tradeoff curve in objective function space; and
determining a subset of the union, each design candidate in the subset corresponding to a point of the tradeoff curve.

3. The method of claim 1, wherein each candidate design approach is a candidate design structure and at least one associated parameter, the associated parameter capable of assuming different values.

4. The method of claim 3, wherein each design candidate is a candidate design structure and a value for each of the at least one associated parameters.

5. The method of claim 3, wherein each candidate design structure is a circuit topology.

6. The method of claim 4, wherein each design candidate is a circuit topology with specific parameter settings for the at least one associated parameter.

7. The method of claim 5 wherein the circuit topology is one of an analog circuit topology and an RF circuit topology.

8. The method of claim 5 wherein the circuit topology is a mixed-signal circuit topology.

9. The method of claim 6 where each design candidate includes a specific placement of devices and a post-processing step includes device routing.

10. The method of claim 6 where each design candidate includes a specific placement of devices, and device routing.

11. The method of claim 6 where post-processing steps include placement of devices, and device routing.

12. The method of claim 3, wherein each candidate design structure is a design structure relating to one of: a chemical process plant design, a control system, a neural network, a regression model of an unknown system, a molecule, an optical circuit, a communications network, a flow network, a road system, an optical design, a waterway, a mechanical component and an opto-electrical component.

13. The method of claim 9, wherein each candidate design structure further comprises at least one parameter associated with the design structure.

14. The method of claim 13, wherein each design candidate comprises a design structure and a value for each of the at least one parameters.

15. The method of claim 1, wherein the step of applying the population based optimization algorithm to the design candidates in the subset to determine the at least one optimized design comprises viewing objective function values in a graphical format for comparing design candidates.

16. The method of claim 1, wherein the step of applying the population based optimization algorithm to the design candidates in the subset to determine the at least one optimized design comprises viewing objective function values in a graphical format for comparing design candidates.

17. A method of circuit design comprising receiving a circuit design problem definition and biases and producing a circuit design, the method comprising:
determining schematics;
simultaneously optimizing all schematics; and
selecting a sized schematic for subsequent processing.

18. The method of claim 17, wherein determining schematics comprises selecting schematics from a plurality of known schematics.

19. The method of claim 17, wherein determining schematics comprises designing schematics.

20. A system for determining at least one optimized design based on a plurality of sets of design candidates, each set of design candidates corresponding to a respective candidate design approach, each design candidate having a corresponding objective function value, the method comprising:
means for taking the union of the plurality of sets of design candidates;
means for determining a population based optimization algorithm for application to the union of the plurality of sets of design candidates;
means for determining, based on the objective function values of the design candidates, a subset of the union; and
means for applying the population based optimization algorithm to the design candidates in the subset to determine the at least one optimized design.
